(19) United States
(12) Patent Application Publication
(10) Pub. No.: US 2019/0118602 A1
(43) Pub. Date: Apr. 25, 2019

(54) HEATING DEVICE FOR HYDRAULIC FLUID DAMPER

(71) Applicant: CURBEATER AS, Fetsund (NO)

(72) Inventor: Andreas BLEGEN, Fetsund (NO)

(21) Appl. No.: 16/094,444

(22) PCT Filed: Apr. 7, 2017
(86) PCT No.: PCT/NO2017/050085

§ 371 Date: Oct. 17, 2018

(30) Foreign Application Priority Data
Apr. 22, 2016 (NO) 20160686

(51) Int. Cl. B60G 17/00; F16F 9/32

(52) U.S. Cl. CPC B60G 17/002; F16F 2222/02; F16F 9/32

(57) ABSTRACT

A heating device for a hydraulic fluid reservoir of a damper, comprising a flexible heating element and a support structure. The support structure supports the flexible heating element such that the flexible heating element is configured to contact and at least partly encompass the fluid reservoir, and the heating device is provided to be releasably connected to the fluid reservoir by side portions provided to bias the flexible heating element to the fluid reservoir.

### FIELD OF THE INVENTION

The invention concerns a heating device for a hydraulic fluid reservoir of a damper, as set out by the preamble of claim 1.

### BACKGROUND OF THE INVENTION

Dampers are found on most vehicles today, including motorcycles, and are used to absorb bumps in the ground on which the vehicle is moving. Dampers as such increase the friction between the tyres and the ground, and ensure a smooth ride and level of comfort for the rider of the motorcycle or vehicle. Dampers also play an important role during accelerating, deceleration and turning. One of the most commonly known damper systems is the oil damper; it converts kinetic energy into heat by utilizing friction and oil flow resistance in the damper. Such dampers are well known in the art.

The properties of the oil changes with the temperature, and so the oil in oil dampers has an optimal working temperature, which can change with different oils and dampers. The damping is also adjusted during riding, in order to compensate for varying damping properties due to the change in temperature. Before a motorcycle race, in order for the oil in the damper to be warm and have more favourable properties, the oil is warmed up. This warm-up is commonly done by riding the motorcycle and braking/accelerating, such that the damper is compressed and extended, resulting in flow of oil in the damper. The oil flow generates heat and thus the oil is warmed up.

Such warm-up is time consuming because the motorcycle or vehicle must be driven in order to heat up the oil, but it is also inaccurate because it is difficult to anticipate the temperature of the oil. Oftentimes it takes several minutes from the warm-up riding until the race actually starts, and so at the start of the race the oil has a less than optimal temperature, resulting in reduced performance during the initial part of a race. An individual riding his or her motorcycle to and from work rarely bothers to warm up the oil in the dampers prior to riding a motorcycle, also resulting in less than optimal working temperature of the oil at the start of the journey, which in turn results in reduced braking, acceleration and turning properties of the vehicle.

### SUMMARY OF THE INVENTION

In order to overcome the problems related to known methods for warming up the oil in dampers, the applicant has devised a heating device which heats the oil in dampers. The invention is set forth and characterized in the main claim, while the dependent claims describe other characteristics of the invention.

It is thus provided a heating device for a hydraulic fluid reservoir of a damper, comprising a flexible heating element and a support structure. The support structure is supporting the flexible heating element such that the flexible heating element is configured to contact and at least partly encompass the fluid reservoir, and the heating device is provided to be releasably connected to the fluid reservoir by side portions provided to bias the flexible heating element to the fluid reservoir.

According to one embodiment, the heating element is supported by the support structure substantially in the shape of a cut cylinder.

According to another embodiment, the heating element is connected to the support structure on distal ends of the support structure.

According to another embodiment, the heating element is hingedly connected to the support structure.

According to another embodiment, the side portions are substantially stiff and rotatable about at least one axis.

According to another embodiment, the side portions are two separate elements connected by a rotational element.

According to another embodiment, the support structure comprises second distal ends for actuation by a user.

According to another embodiment, where the heating device is for releasably connection to an oil reservoir of a vehicle.

In order to more efficiently and less cumbersome pre-heat the oil of an oil damper, to reduce risk for the person riding the vehicle and increase performance of the vehicle, the applicant has devised a heating device which is easy to use and which accurately heats the oil in the oil damper to the optimal temperature. The heating device is applicable for both professional use and for individuals.

The heating device is easy to use and eliminates the need of riding or driving a vehicle for the purpose of warming up the damper oil. It has a low threshold for use both on a daily basis for individuals and on a race track for experienced riders and professionals. The heating device provides heat to the oil which in turn maximises the damping properties of an oil damper right from the start of a daily commute or a track race.

### BRIEF DESCRIPTION OF THE DRAWINGS

These and other characteristics of the invention will become clear from the following description of an embodiment, given as a non-restrictive example, with reference to the attached schematic drawings, wherein:

FIG. 1 is a perspective view of the heating device connected to an oil damper on a front fork of a motorcycle.

FIG. 2 is a perspective view of the heating device.

FIG. 3 is a top view of the heating device.

### DETAILED DESCRIPTION OF A PREFERENTIAL EMBODIMENT

The following description may use terms such as “horizontal”, “vertical”, “circumferential”, “up”, “down”, “inner”, “outer”, “forward”, “rear”, etc. These terms generally refer to the views and orientations as shown in the drawings and that are associated with a normal use of the invention. The terms are used for the reader's convenience only and shall not be limiting.

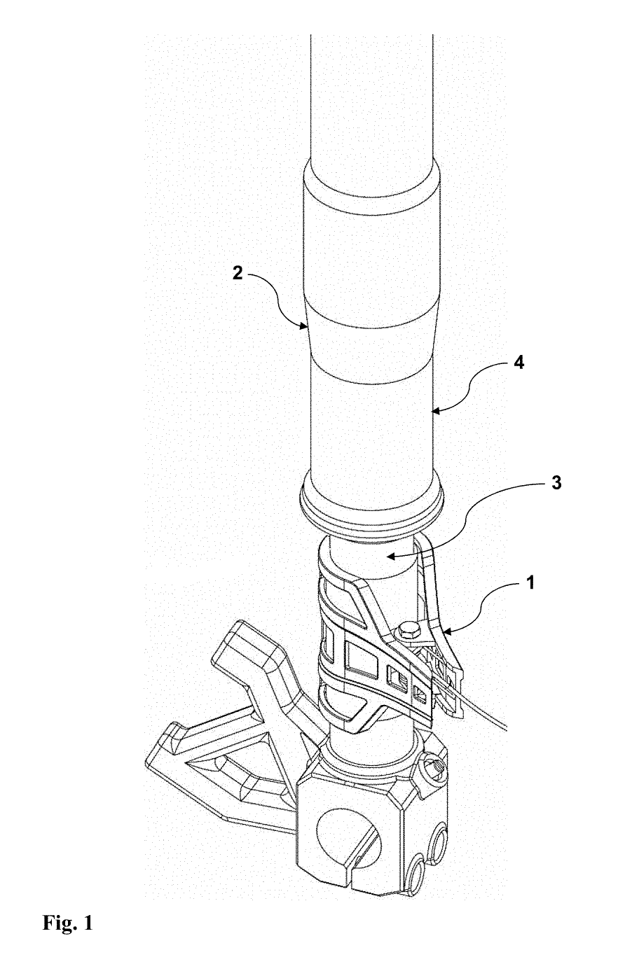

FIG. 1 illustrates the heating device 1 connected to an oil damper 2. In the illustrated embodiment the oil damper 2 is part of the front fork of a motorcycle. The front fork of a motorcycle comprises a fork stanchion 3 and fork slider 4. The oil is located inside both the fork stanchion 3 and fork slider 4, and these parts form an oil reservoir. The heating device 1 could as such be affixed to almost any part of the oil damper 2. However, the best heating effect occurs when the heating device 1 is positioned as close to the oil as possible. In the illustrated embodiment, the heat loss from the heating device 1 to the oil is lowest when the heating device 1 is connected directly to the fork stanchion 3, which has a smaller wall thickness than the fork slider 4. The heating device 1 could be affixed to almost any oil reservoir of any oil damper where the reservoir is easily accessible, such as the oil reservoir of a motorcycle rear damper, oil dampers for automobiles, three-wheelers, snowmobiles, etc. Most dampers use oil for the damping, but any hydraulic fluid could be utilized and the heating device could thus be used to heat any such hydraulic fluid.

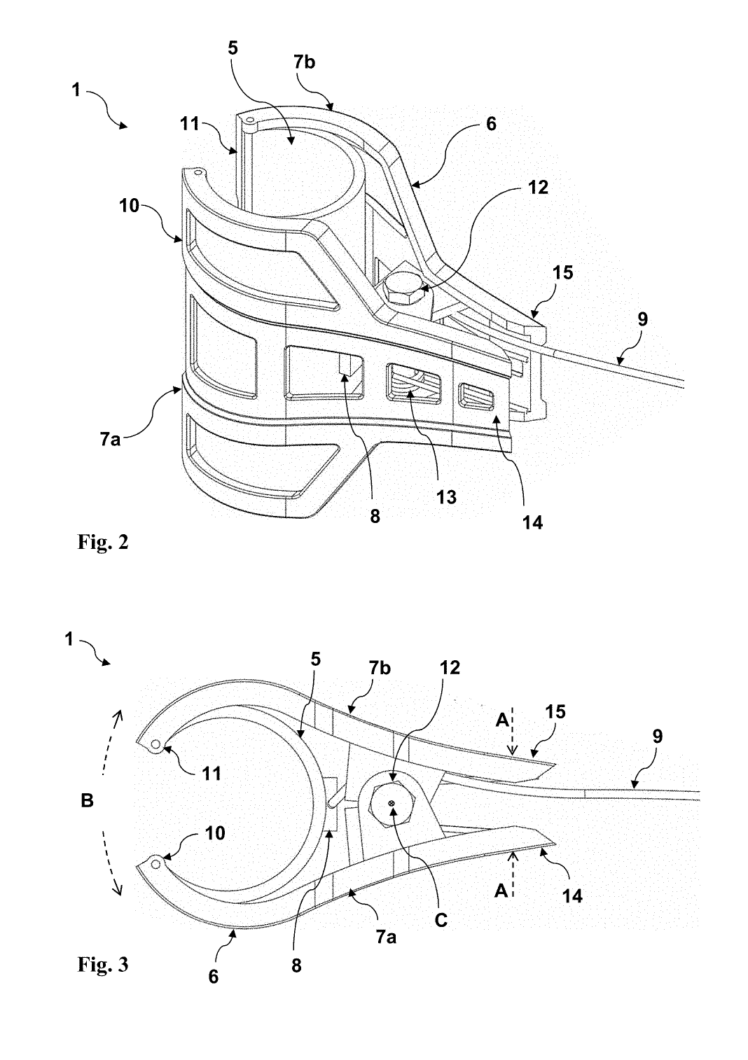

FIGS. 2 and 3 shows the heating device 1 isolated, i.e. not connected to an oil damper. The heating device 1 comprises a heating element 5. In the illustrated embodiment, the heating element 5 is positioned in a support structure 6, comprising a first side portion 7a and a second side portion 7b. The heating element 5 is flexible and malleable, and it is supported in between the two side portions 7a,b such that it has the shape of a generally cut cylinder. As the heating element 5 is flexible and malleable, it will adapt to the shape of an external surface of an oil reservoir and at least partly encompass it. Most oil reservoirs are cylindrical or substantially cylindrical, and so the heating element 5 is capable of being connected to oil reservoirs with different diameters.

The height of the heating device 1, measured from the lowest portion to the highest portion of the heating device 1 when the device is standing upright, as illustrated in FIG. 2, is approximately 100 mm. The height could be as much as 110 mm or more, but the visible (and accessible) part of a fork stanchion 3 (from FIG. 1) has a height in the axial direction usually about 110-120 mm when a typical motorcycle is standing still and both the rear and front suspension is somewhat compressed due to the curb weight of the vehicle. The heating device 1 shall not be limited to the above dimensions, as it may be dimensioned to accommodate fork stanchions 3 of almost any motorcycle, and at the same time cover as much of the visible fork stanchion 3 as possible. The heating device 1 will also function even if it extends in the axial direction beyond the oil reservoir to be heated, for instance when placed on an oil reservoir of a rear damper, commonly having an axial height of 50-100 mm.

The heating element 5 comprises electrical wire, foil, or other similar components known to generate heat when connected to a power source, such as metal heating elements, ceramic heating elements or even polymer PTC heating elements. The heating element 5 may have a thermostat such that the temperature can be controlled and adjusted. The thermostat may be positioned on the heating element 5 itself, or in the proximity thereof. If e.g. a PTC heating element is used, the heating element could automatically adjust to a constant temperature. The heating device 1 may also comprise a control device for setting the desired temperature, or even a timer, in order to reduce risk of the oil overheating. Such a control device may also be located a distance away from the heating device 1, e.g. in connection with the wire 9.

The inside of the heating element 5, i.e. the face of the heating element 5 contacting the oil reservoir, may have a surface which reduces slip. Such a surface could be made of a soft compound like silicone, fabric, or other similar material which transfers heat, but has a relatively high friction coefficient with metal and plastic, which oil reservoirs are commonly made from. A terminal 8 connects an electrical wire 9 to the heating element 5. The electrical wire 9 connects the heating device 1 to a power source such as a transformer or a battery unit.

When in a flat state, the heating element 5 as illustrated has a rectangular shape with four sides, but it could have several different shapes and configurations as such. In the illustrated embodiment, two opposite sides of the heating element 5 is connected to a first distal end 10 of the first side portion 7a and to a first distal end 11 of the second side portion 7b. The connections are hinged, such that one side of the heating element 5 is free to rotate about the first distal end 10 of the first side portion 7a, and the opposite side of the heating element 5 is free to rotate about the first distal end 11 of the second side portion 7b, thereby allowing the heating element 5 to be releasably connected to, and disconnected from, an oil reservoir. The connections need not be hinged, but hinges will allow for more and better flexibility of the heating element 5. The heating element 5 in the heating device 1 has a shape that at least partially is complementary to the external surface of a fluid reservoir, i.e. it has substantially the shape of a segment of a cut, hollow cylinder, making it easy to establish sufficient contact between the heating element 5 and a cylindrical or near-cylindrical oil reservoir, and maximising heat to be transferred from the heating element to the oil reservoir.

The first and second side portions 7a,b are stiff and connected to each other by a bolt 12 which acts as an axis of rotation C for the first and second side portions. Instead of a bolt, any known means for connecting two parts in a rotatable way could be utilized, such as a rod, or the side portions could even be connected to themselves and together form an axis of rotation C. A spring 13 is positioned between the side portions 7a,b, in the illustrated embodiment coiled up around the bolt 12, and biases a second distal end 14 of the first side portion 7a away from a second distal end 15 of the second side portion 7b. In effect, the two first distal ends 10,11 (and the sides of the heating element 5 connected thereto) are forced towards each other, creating a pinch which, when the heating element 1 is clamped on an oil reservoir, hugs the heating device 1 and the heating element 5 to the oil reservoir.

The side portions 7a,b could have a slightly curved shape, as seen in the top view in FIG. 3. The side portions 7a,b are curved inwards, from approximately where the axis of rotation C is located until the first distal ends 10,11. The convex shape of the side portions 7a,b provides the heating element 5 to contact an oil reservoir more than halfway around the circumference of the oil reservoir. A larger diameter and more convex shape of the side portions 7a,b will enable the heating element 5 to contact a larger area around the outer surface of a cylindrical oil reservoir, and will also make the heating device 1 compatible with oil reservoirs of a greater diameter. As much as possible of the oil reservoir (in the tangential direction) should be in contact with the heating element 5.

To separate the first distal ends 10,11 of the heating device, in order to allow the heating device 5 to enter and be mounted on an oil reservoir or to remove the heating element 1 from an oil reservoir, the two second ends 14,15 must be moved towards each other. The first distal ends 10,11 will then rotate away from each other in a direction indicated by arrows B in FIG. 3. The first side portion 7a and the second side portion 7b of the heating device 5 thus functions as tilting members, tilting about the axis C through the bolt 12. A user of the heating device 1 will typically use his or her hands to pinch the second distal ends 14,15 together in the direction of the arrows A in FIG. 3. The biasing force of the spring 13 should thus be adequate to securely affix the heating device 1 to an oil reservoir, but the heating device should also be operable by only one hand of the user, and the biasing force should thus be adjusted to this.

The side portions 7a,b could be made substantially symmetrical, or even identical, in order to ease the production thereof. The side portions 7a,b could be made from metal or an electrically insulating material such as plastic, and be manufactured by e.g. injection moulding. An electrically insulating material would prevent the second distal ends 14,15 from heating up, which would make the heating device 1 more comfortable to pinch by bare hands when removing it from an oil reservoir after use.

An alternative (not illustrated) embodiment of the heating device comprises a support structure as one component. The general shape of such a support structure is similar to that of the support structure 6, but the two side portions (corresponding to the side portions 7a,b) are cast or otherwise manufactured as one part. In its non-biased state such a support structure should have a shape where the distance between the two first distal ends (corresponding to the first distal ends 10,11 in the illustrated embodiment) is small, i.e. approximately 0-30 mm. When the two second distal ends (corresponding to the second distal ends 14,15 of the illustrated embodiment) are pinched together, the connecting portion (i.e. the area where the bolt 12 in the illustrated embodiment connects the two side portions 7a,b) functions as an axis of rotation, but without any assembled elements. The connecting portion may even be designed such that the two side portions have two or more different axes of rotation, because bending and flexing of a material does not necessarily rotate the two side portions about only one axis. Such a heating device should be made from a material with flexible properties, but which also has a certain degree of stiffness, such as plastic or a metal with high elasticity.

In this alternative embodiment, the two side portions of the support element (corresponding top the first and second side portions 7a,b of the illustrated embodiment) could be made stiffer (e.g. with greater material thickness) than the connecting portion (corresponding to the bolt 12 and spring 13 of the illustrated embodiment). When pinched at the second distal ends, similarly to that illustrated by arrows A in FIG. 3, the side portions of the support element will rotate the first distal ends away from each other in a direction similar to that illustrated by arrow B in FIG. 3. When the heating device is connected to an oil reservoir and the second distal ends are released, the support element will try to return to its initial state or geometry; this creates a pinch which secures it to the oil reservoir, similar to what the spring 13 does to the side portions in the illustrated embodiment.

If there is a small distance between the first distal ends of this alternative embodiment, or if the distal ends are shaped is such a way that the distal ends will separate when the heating device is biased against an oil reservoir such as a fork stanchion, the second distal ends might even be superfluous, and the heating device could be applied to the oil reservoir simply by forcing it onto the oil reservoir, resulting in the first distal ends to separate and allowing the oil reservoir to enter and be retained within the support structure and heating element.

While the invention has been illustrated and described in detail in the drawings and foregoing description, such illustration and description are to be considered illustrative or exemplary and not restrictive and it is not intended to limit the invention to the disclosed embodiments.

1. A heating device for a hydraulic fluid reservoir of a damper, comprising:
a flexible heating element and a support structure, the support structure supporting the flexible heating element such that the flexible heating element is configured to contact and at least partly encompass the fluid reservoir, the heating device configured to be releasably connected to the fluid reservoir by side portions provided to bias the flexible heating element to the fluid reservoir.

2. The heating device of claim 1, wherein the flexible heating element is supported by the support structure, wherein the flexible heating element is substantially shaped as a cut cylinder.

3. The heating device of claim 1 wherein the flexible heating element is connected to first distal ends of the support structure.

4. The heating device of claim 1, wherein the flexible heating element is hingedly connected to the support structure.

5. The heating device of claim 1, wherein the side portions are substantially stiff and rotatable about at least one axis.

6. The heating device of claim 1, wherein the side portions are two separate elements connected by a rotational element.

7. The heating device of claim 1, wherein the support structure further comprises second distal ends for actuation by a user.

8. The heating device of claim 1, configured to be releasably connected to an oil reservoir of a vehicle.
